(19) United States
(12) Patent Application Publication
(10) Pub. No.: US 2016/0183294 A1
(43) Pub. Date: Jun. 23, 2016

(54) Base station and terminal of wireless communication system

(71) Applicant: Electronics and Telecommunications Research Institute, Daejeon (KR)

(72) Inventors: Taegyun Noh, Daejeon (KR); Young Jo Ko, Daejeon (KR); Seung Chan Bang, Daejeon (KR)

(73) Assignee: Electronics and Telecommunications Research Institute

(21) Appl. No.: 14/757,605

(22) Filed: Dec. 23, 2015

(30) Foreign Application Priority Data
Dec. 23, 2014 (KR) 10-2014-0187234
Dec. 23, 2015 (KR) 10-2015-0185248

(51) Int. Cl. H04W 72/14; H04L 5/00; H04W 72/04; H04W 72/12

(52) U.S. Cl. CPC H04W 72/14; H04W 72/1284; H04W 72/1294; H04L 5/0055; H04W 72/0446; H04W 88/02

(57) ABSTRACT

A base station and terminal that transmit/receive scheduling information about a data channel through a first carrier and that transmit/receive a data channel corresponding to scheduling information through a second carrier having a carrier type different from that of the first carrier are provided.

### CROSS-REFERENCE TO RELATED APPLICATION

This application claims priority to and the benefit of Korean Patent Application Nos. 10-2014-0187234 and 10-2015-0185248 filed in the Korean Intellectual Property Office on Dec. 23, 2014, and Dec. 23, 2015, the entire contents of which are incorporated herein by reference.

### BACKGROUND OF THE INVENTION

(a) Field of the Invention

The present invention relates to a base station and a terminal of a wireless communication system using carrier aggregation.

(b) Description of the Related Art

In a conventional wireless communication system, a Transmission Time Interval (TTI) of a physical channel is a subframe. The subframe is formed with two slots, and each slot includes a plurality of symbols. In this case, the entire of the subframe, the slot, and the symbol is a unit of a radio resource that is defined in a time domain. In order to reduce delay of data transmission/reception, it necessary to shorten a TTI, and in a present wireless communication system, when a short TTI is used, a problem that a specification change is inevitable may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a base station having advantages of transmitting/receiving, scheduling information and a data channel corresponding thereto using a carrier having different TTIs. The present invention has been made in an effort to further provide a terminal having advantages of transmitting/receiving scheduling information and a data channel corresponding thereto using a carrier having different TTIs.

An exemplary embodiment of the present invention provides a terminal, comprising: at least one processor; a memory; and a radio frequency unit, wherein by executing at least one program that is stored at the memory, the at least one processor selects a type of a carrier to transmit a Physical Uplink Shared Channel (PUSCH) based on a transfer time that is required for transferring an uplink data packet and transmits a Scheduling Request (SR) to a base station through a first carrier of carriers having the selected carrier type.

When executing the at least one program, the at least one processor may receive Uplink grant (UL grant) from the base station through a second carrier having the same type as that of the first carrier, transmit a PUSCH to the base station through a third carrier in which the UL grant indicates, and receive Downlink ACK/NACK (DN A/N) from the base station through the second carrier.

The second carrier may be a Subframe TTI (SFT) carrier in which a Transmission Time Interval (TTI) is one subframe, and the third carrier may be a One Slot TTI (OST) carrier in which the TTI is one slot.

When receiving Downlink ACK/NACK (DN A/N), the at least one processor may transmit the PUSCH and receive the DL A/N after two slots when receiving the UL grant and transmitting the PUSCH to the base station after one slot, and transmit the PUSCH and receive the DL A/N after one slot when receiving the UL grant and transmitting the PUSCH to the base station after two slots.

The first carrier and the second carrier may be the same carrier.

When transmitting the PUSCH, the at least one processor may determine a One Slot TTI (OST) to transmit the PUSCH based on a slot index that is included in the UL grant and transmit the PUSCH at the determined OST.

When transmitting the PUSCH, the at least one processor may determine a One Slot TTI (OST) to transmit the PUSCH based on a scheduling indicator that is included in the UL grant and transmit the PUSCH at the determined OST.

Another embodiment of the present invention provides, a base station, comprising: at least one processor; a memory; and a radio frequency unit, wherein by executing at least one program that is stored at the memory, the at least one processor selects a type of a carrier to transmit a Physical Uplink Shared Channel (PUSCH) based on a Buffer Status Report (BSR) that is received from a terminal, transmits Uplink grant (UL grant) to the terminal through a first carrier having a type different from the selected carrier type, and receives the PUSCH through a second carrier that is instructed to the UL grant among the selected carrier types.

When executing the at least one program, the at least one processor may transmit Downlink ACK/NACK (DL A/N) corresponding to the PUSCH to the terminal through the first carrier.

The first carrier may be a Subframe TTI (SFT) carrier in which a Transmission Time Interval (TTI) is one subframe, and the second carrier may be a One Slot TTI (OST) carrier in which the TTI is one slot.

When transmitting the DL A/N, the at least one processor may receive the PUSCH and transmits the DL A/N after two slots when transmitting the UL grant and receiving the PUSCH from the terminal after one slot, and receives the PUSCH, and transmit the DL A/N after one slot when transmitting the UL grant and receiving the PUSCH from the terminal after two slots.

Yet another embodiment of the present invention provides a base station, comprising: at least one processor; a memory; and a radio frequency unit, wherein by executing at least one program that is stored at the memory, the at least one processor selects a type of a carrier to transmit a Physical Downlink Shared Channel (PDSCH) based on a transfer time that is required for transferring a downlink data packet, transmits the PDSCH to the terminal through a first carrier of carriers having the selected carrier type, and receives Uplink ACK/NACK (UL A/N) corresponding to the PDSCH from a terminal through a second carrier having a carrier type different from the selected carrier type.

The first carrier may be a One Slot TTI (OST) carrier in which a Transmission Time Interval (TTI) is one slot, and the second carrier may be a Subframe TTI (SFT) carrier in which the TTI is a one subframe.

When executing the at least one program, the at least one processor may transmit Downlink assignment (DL assignment) corresponding to the PDSCH to the terminal through the first carrier.

When transmitting the PDSCH, the at least one processor may transmit the PDSCH to the terminal after one OST when receiving UL A/N corresponding to a PDSCH that is transmitted at an odd numbered OST of two OSTs that are included in the SFT from the terminal and transmit the PDSCH to the terminal after two OSTs when receiving UL A/N corresponding to a PDSCH that is transmitted at an even numbered OST of the two OSTs from the terminal.

When executing the at least one program, the at least one processor may transmit Downlink assignment (DL assignment) corresponding to the PDSCH to the terminal through the second carrier.

When transmitting the PDSCH, the at least one processor may transmit the PDSCH to the terminal after two OSTs when receiving UL A/N corresponding to a PDSCH that is transmitted at an even numbered OST of two OSTs that are included in the SFT from the terminal and transmit the PDSCH to the terminal after three OSTs when receiving UL A/N corresponding to a PDSCH that is transmitted at an odd numbered OST of the two OSTs from the terminal.

The DL assignment may include a slot index representing whether a PDSCH in which the DL assignment schedules is scheduled at an even numbered OST or at an odd numbered OST.

The DL assignment may include a scheduling indicator that represents a PDSCH that is scheduled at an even numbered OST and a PDSCH that is scheduled at an odd numbered OST.

### BRIEF DESCRIPTION OF THE DRAWINGS

FIG. 1 is a diagram illustrating a TTI of each carrier according to an exemplary embodiment of the present invention.

FIG. 2 is a diagram illustrating a downlink HARQ and an uplink HARQ that are performed in an OST carrier of an FDD system according to an exemplary embodiment of the present invention.

FIG. 3 is a schematic view illustrating downlink HARQ timing according to an exemplary embodiment of the present invention.

FIG. 4 is a schematic view illustrating downlink HARQ timing according to another exemplary embodiment of the present invention.

FIG. 5 is a schematic view illustrating uplink HARQ timing according to an exemplary embodiment of the present invention.

FIG. 6 is a block diagram illustrating a wireless communication system according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

In an entire specification, a terminal may indicate a mobile station (MS), a mobile terminal (MT), an advanced mobile station (AMS), a high reliability mobile station (HR-MS), a subscriber station (SS), a portable subscriber station (PSS), an access terminal (AT), an user equipment (UE), and a machine type communication device (MTC device) and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, a relay node(RN) that performs a BS function, an advanced relay station (ARS) that performs a BS function, a high reliability relay station (HR-RS) that performs a BS function, and a small BS[a femto BS, a home node B(HNB), a home eNodeB (HeNB), a pico BS, a macro BS, and a micro BS] and may include an entire function or a partial function of the ABS, the nodeB, the eNodeB, the AP, the RAS, the BTS, the MMR-BS, the RS, the RN, the ARS, the HR-RS, and the small BS.

A base station according to an exemplary embodiment of the present invention may perform a function of a control device that controls one cell. A base station of a general wireless communication system may control a plurality of cells, and in this case, a base station may include a plurality of base stations according to an exemplary embodiment of the present invention. Therefore, a parameter that is allocated to each cell may be allocated to each cell With different values by a base station according to an exemplary embodiment of the present invention.

Further, in an exemplary embodiment of the present invention, a Physical Downlink Shared Channel (PDSCH) and a Physical Uplink Shared Channel (PUSCH) represent a physical downlink data channel and a physical uplink data channel, respectively. Down Link ACK/NACK (DL A/N) represents whether demodulation of a PUSCH is succeeded, and a base station transmits DL A/N to a terminal through a Physical Hybrid-Automatic Repeat reQuest (ARQ) Indicator Channel (PHICH). Up Link ACK/NACK (UL A/N) represents whether demodulation of a PDSCH is succeeded, and a terminal transmits UL A/N to a base station through a Physical Uplink Control Channel (PUCCH). UL A/N or a Scheduling Request (SR) may be transmitted through the PUCCH. When the terminal requests uplink resource allocation to the base station, the SR is used. Up Link grant (UL grant) represents scheduling information about a PUSCH, and the terminal may transmit the PUSCH to the base station according to UL grant that is received from the base station. Downlink assignment (DL assignment) represents scheduling information about a PDSCH, and the terminal may receive the PDSCH from the base station according to DL assignment that is received from the base station. A Physical Downlink Control Channel (PDCCH) is a channel that transfers UL grant or DL assignment to the terminal. A Buffer Status Report (BSR) is a report on a buffer state of an uplink channel in which the terminal transmits to the base station.

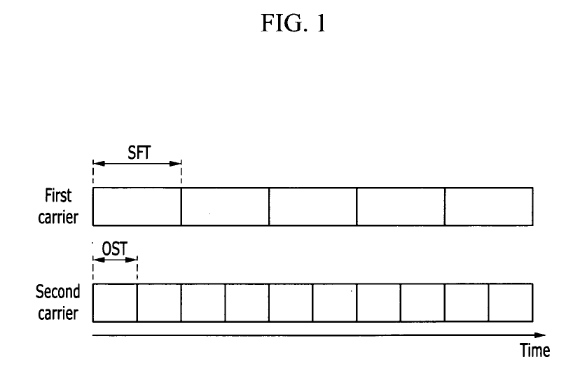

FIG. 1 is a diagram illustrating a TTI of each carrier according to an exemplary embodiment of the present invention.

Carrier Aggregation (CA) is technology for transmitting/receiving a physical channel and a signal using a plurality of carriers, and a TTI in which a physical channel and a signal are transmitted on an aggregated carrier basis may be different. Referring to FIG. 1, a TTI of a first carrier is a Subframe TTI (SFT), and a TTI of a second carrier is a One Slot TTI (OST). In an exemplary embodiment of FIG. 1, it is assumed that two TTIs of an SFT and an OST exist and that one carrier exists in each TTI, and in another exemplary embodiment, at least three TTIs may exist, and in each TTI, a plurality of carriers may exist. In this case, CA between a plurality of carriers having the same TTI may follow a specification of 3^{rd} Generation Partnership Project (3GPP) Long Term Evolution (LTE).

A physical channel may be transmitted from each carrier according to CA. However, a Physical Uplink Control Channel (PUCCH) of physical channels may be transmitted only in a specific one carrier or may be transmitted over a plurality of carriers according to a path loss between a terminal and a base station and transmission power of an uplink physical channel.

For example, when a path loss between the terminal and the base station is small, even if the terminal simultaneously transmits a PUCCH from a plurality of carriers, the base station may successfully demodulate the PUCCH that is transmitted from each carrier. In this case, a plurality of carriers each may include at least one carrier having different TTIs. That is, according to an exemplary embodiment, a plurality of carriers may include at least one carrier (hereinafter, referred to as an ‘SFT carrier’) having an SFT and may include at least one carrier (hereinafter, referred to as an ‘OST carrier’) having an OST.

However, when a path loss between the terminal and the base station is large, if the terminal simultaneously transmits a PUCCH from a plurality of carriers, the base station may fail in demodulation of at least one PUCCH. In this case, in order to guarantee successful demodulation of the PUCCH, the PUCCH may be transmitted only in a predetermined one carrier. In this case, a predetermined one carrier may be an SFT carrier. In an exemplary embodiment, a method in which a terminal transmits a PUCCH from a predetermined one carrier is referred to as a first PUCCH transmitting method, and a method in which a terminal simultaneously transmits a PUCCH from a plurality of carriers is referred to as a second PUCCH transmitting method.

The base station may notify the terminal of a PUCCH transmitting method through superordinate layer signaling. In this case, superordinate layer signaling may be Radio Resource Control (RRC) signaling or system information. Specifically, there are three methods in which the base station notifies the terminal of a PUCCH transmitting method through superordinate layer signaling. A first method is a method of explicitly notifying a transmitting method (first PUCCH transmitting method or second PUCCH transmitting method) of a PUCCH through superordinate layer signaling. A second method is a method of using a first PUCCH transmitting method when superordinate layer signaling does not exist and setting a second PUCCH transmitting method through superordinate layer signaling. In the second method, a default transmitting method of a PUCCH is a first PUCCH transmitting method. A third method is a method of using a second PUCCH transmitting method when superordinate layer signaling does not exist and setting a first PUCCH transmitting method through superordinate layer signaling. In the third method, a default transmitting method of a PUCCH is a second PUCCH transmitting method.

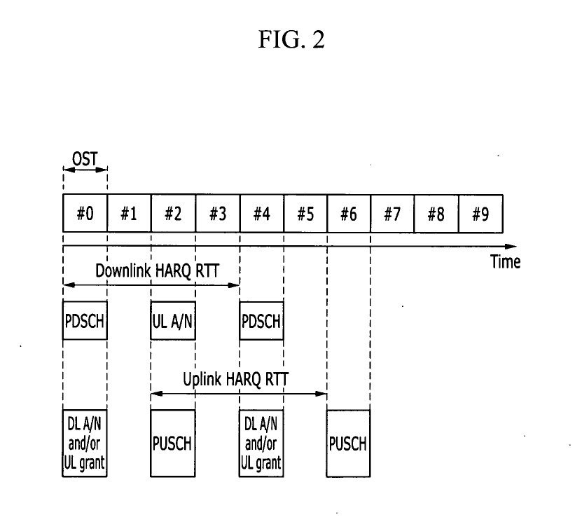

FIG. 2 is a diagram illustrating a downlink HARQ and an uplink HARQ that are performed in an OST carrier of a Frequency-Division Duplexing (FDD) system according to an exemplary embodiment of the present invention.

HARQ timing of an OST carrier may be different from HARQ timing that is performed in an SFT carrier. Downlink HARQ timing of an OST carrier will be described with reference to FIG. 2. When the terminal receives a PDSCH from the base station, the terminal transmits UL A/N to the base station after one OST. The base station receives UL A/N from the terminal and transmits a PDSCH to the terminal after one OST. Therefore, in an OST carrier, a Round Trip Time (RTT) of a downlink HARQ corresponds to four OST times. In this case, the number of downlink HARQ processes is 4.

Thereafter, uplink HARQ timing of an OST carrier will be described with reference to FIG. 2. When the terminal receives DL A/N or UL grant, or DL A/N and UL grant from the base station, the terminal transmits a PUSCH to the base station after one OST. When the base station receives a PUSCH from the terminal, the base station transmits DL A/N or UL grant, or DL A/N and UL grant to the terminal after one OST. Therefore, an uplink HARQ RTT corresponds to four OST times, and in this case, the number of uplink HARQ processes is 4.

In a first PUCCH transmitting method, because a PUCCH is transmitted from an SFT carrier, HARQ timing of an OST carrier may be different from that of FIG. 2. Specifically, HARQ timing may be different from that of FIG. 2 according to whether DL assignment corresponding to a PDSCH occurring in an OST carrier and UL grant of a PUSCH occurring in an OST carrier is transmitted through which carrier of an OST carrier or an SFT carrier.

First, a case in which UL grant corresponding to a PUSCH occurring in an OST carrier is transmitted through the OST carrier will be described. In this case, because the entire of a PUSCH, UL grant, and DL A/N occurs in an OST carrier, uplink HARQ timing is the same as that of FIG. 2.

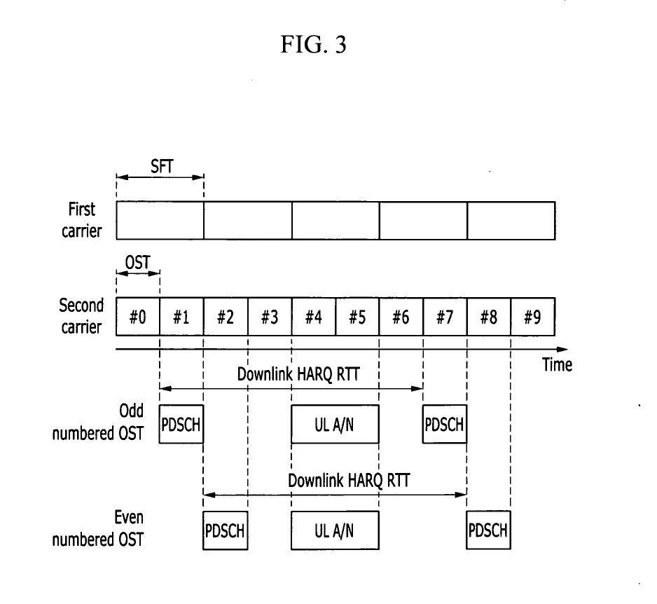

FIG. 3 is a schematic view illustrating downlink HARQ timing according to an exemplary embodiment of the present invention.

FIG. 3 illustrates downlink HARQ timing when DL assignment corresponding to a PDSCH that is transmitted from an OST carrier is transmitted through the OST carrier. Referring to FIG. 3, the PDSCH occurs in the OST carrier, but UL A/N occurs in an SFT carrier according to a first PUCCH transmitting method. The terminal requires one OST time as a minimum processing time for receiving the PDSCH and transmitting UL A/N. Further, the base station requires one OST time as a minimum processing time for receiving UL A/N and transmitting the PDSCH. In consideration that UL A/N of a PDSCH occurring at an odd numbered OST and UL A/N of a PDSCH occurring at an even numbered OST, which is an OST immediate after the odd numbered OST are transmitted at the same time, downlink HARQ timing is the same as that of FIG. 3.

Specifically, when the terminal receives a PDSCH from the base station at an odd numbered OST, the terminal transmits UL A/N to the base station after two OST times. When the base station receives UL A/N corresponding to a PDSCH that is transmitted at an odd numbered OST from the terminal, the base station transmits the PDSCH to the terminal after one OST time. When the terminal receives a PDSCH from the base station at an even numbered OST, the terminal transmits UL A/N to the base station after one OST time. When the base station receives UL A/N corresponding to a PDSCH that is transmitted at an even numbered OST from the terminal, the base station transmits the PDSCH to the terminal after two OST times. Therefore, a downlink HARQ RTT is the same as six OST times, and the number of downlink HARQ processes is 6.

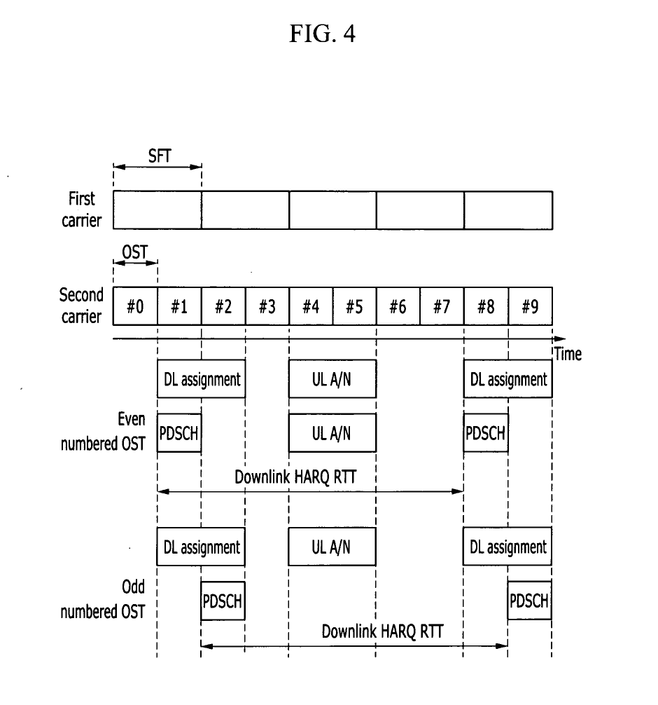

FIG. 4 is a schematic view illustrating downlink HARQ timing according to another exemplary embodiment of the present invention.

FIG. 4 illustrates downlink HARQ timing when DL assignment corresponding to a PDSCH that is transmitted from an OST carrier is transmitted through an SFT carrier. Referring to FIG. 4, a PDSCH occurs in an OST carrier, but UL A/N occurs in an SFT carrier and DL assignment occurs in an SFT carrier according to a first PUCCH transmitting method. The terminal may receive DL assignment and demodulate the PDSCH. In this case, as a minimum processing time for receiving the PDSCH and transmitting UL A/N, the terminal requires one OST time. Further, as a minimum processing time for receiving the UL A/N and transmitting the PDSCH, the base station requires one OST time. In consideration that UL A/N corresponding to a PDSCH occurring at an even numbered OST and UL A/N corresponding to a PDSCH occurring at an odd numbered OST, which is an OST immediate after the even numbered OST are each transmitted at the same time, downlink HARQ timing is the same as that of FIG. 4.

Specifically, when the terminal receives a PDSCH from the base station at an even numbered OST, the terminal transmits UL A/N to the base station after three OSTs. Thereafter, when the base station receives UL A/N corresponding to a PDSCH that is transmitted at an even numbered OST from the terminal, the base station transmits the PDSCH to the terminal after two OSTs. Further, when the terminal receives the PDSCH from the base station at an odd numbered OST, the terminal transmits UL A/N to the base station after two OSTs. Thereafter, when the base station receives UL A/N corresponding to a PDSCH that is transmitted at an odd numbered OST from the terminal, the base station transmits the PDSCH to the terminal after three OSTs. In this case, a downlink HARQ RTT is the same as eight OST time intervals, and the number of downlink HARQ processes is 8.

When DL assignment of a PDSCH that has occurred in an OST carrier is transmitted through an SFT. carrier, for a time in which one DL assignment is transmitted, two PDSCHs may be transmitted. In this case, DL assignment corresponding to two PDSCHs may be two or one.

When DL assignment corresponding to two PDSCHs is two, each DL assignment may schedule one PDSCH. In this case, it is necessary to distinguish whether DL assignment schedules a PDSCH at an even numbered OST or at an odd numbered OST, and for this reason, in the DL assignment, a slot index may be included. In this case, a slot index may be 1 bit. In an exemplary embodiment, it may be represented whether a PDSCH in which DL assignment schedules is an even numbered OST or an odd numbered OST through a slot index that is included in the DL assignment. For example, DL assignment including a slot index that indicates an odd numbered OST schedules a PDSCH that is transmitted from an odd numbered OST. Alternatively, DL assignment including a slot index that indicates an even numbered OST schedules a PDSCH that is transmitted at an even numbered OST.

When DL assignment corresponding to two PDSCHs is one, one DL assignment may schedule two PDSCHs. In this case, DL assignment includes a scheduling indicator, and two PDSCHs may be scheduled through the scheduling indicator. For example, when the scheduling indicator is 2 bits, 1 bit may represent a PDSCH that is scheduled at an even numbered OST, and the remaining 1 bit may represent a PDSCH that is scheduled at an odd numbered OST. For example, when the entire two bits, which are a scheduling indicator are set to 1, it means that two PDSCHs are scheduled by the same one DL assignment.

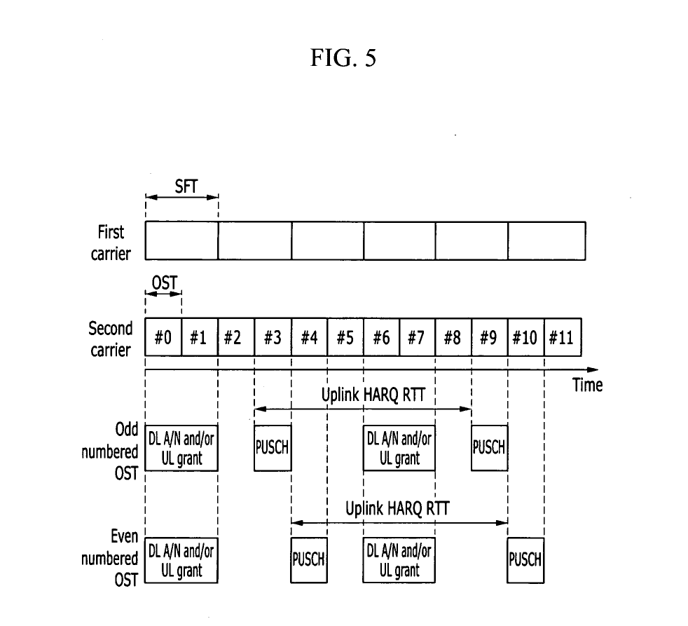

FIG. 5 is a schematic view illustrating uplink HARQ timing according to an exemplary embodiment of the present invention.

FIG. 5 illustrates uplink HARQ timing when a PUSCH is transmitted from an OST carrier and UL grant and DL A/N thereof is transmitted from an SFT carrier. Referring to FIG. 5, the PUSCH occurs in the OST carrier, but DL A/N and UL grant occurs in the SFT carrier. The terminal requires one OST time as a minimum processing time necessary for receiving UL grant, or DL A/N, or UL grant and DL A/N and transmitting the PUSCH. Further, the base station requires one OST time as a minimum processing time necessary for receiving the PUSCH and transmitting UL grant, or DL A/N, or UL grant and DL A/N. Because UL grant, or DL A/N, or UL grant and DL A/N corresponding to a PUSCH that has occurred at an odd numbered OST and a PUSCH that has occurred at an even numbered OST, which is a next OST of the odd numbered OST is transmitted at the same time, uplink HARQ timing is the same as that of FIG. 5.

Specifically, the base station receives a PUSCH from the terminal at an odd numbered OST and transmits UL grant, or DL A/N, or UL grant and DL A/N to the terminal after two OSTs. When the terminal receives UL grant, or DL A/N, or UL grant and DL A/N corresponding to a PUSCH that is transmitted at an odd numbered OST from the base station, the terminal transmits the PUSCH to the base station after one OST. Further, the base station receives the PUSCH from the terminal at an even numbered OST and transmits UL grant, or DL A/N, or UL grant and DL A/N to the terminal after one OST. When the terminal receives UL grant, or DL A/N, or UL grant and DL A/N corresponding to a PUSCH that is transmitted at an even numbered OST, the terminal transmits the PUSCH to the base station after two OSTs. In this case, the uplink HARQ RTT is the same as six OST times, and the number of uplink HARQ processes is 6.

When UL grant and DL A/N corresponding to a PUSCH occurring in an OST carrier is transmitted from an SFT carrier, at a time in which the UL grant is transmitted, two PUSCHs may be scheduled. In this case, UL grant corresponding to two PUSCHs may be two or one. When two UL grants correspond to two PUSCHs, one UL grant may schedule one PUSCH. In this case, in order to distinguish whether a PUSCH in which UL grant schedules is transmitted at an even numbered OST or an odd numbered OST, a slot index may be included in the UL grant. The slot index that is included in the UL grant may be 1 bit. In an exemplary embodiment, a slot index may represent whether an OST in which the PUSCH is transmitted is an even numbered OST or an odd numbered OST. UL grant that includes a slot index that indicates the odd numbered OST may schedule a PUSCH that is transmitted at the odd numbered OST. UL grant that includes a slot index that indicates the even numbered OST may schedule a PUSCH that is transmitted at the even numbered OST.

When UL grant corresponding to two PUSCHs is one, in order to schedule two PUSCHs through one UL grant, a scheduling indicator is included in the UL grant. For example, when the scheduling indicator is 2 bits, 1 bit may indicate scheduling of a PUSCH that is transmitted at an even numbered OST and the remaining 1 bit may indicate scheduling of a PUSCH that is transmitted at an odd numbered OST. When the entire 2bits of the scheduling indicator are set to 1, it means that two PUSCHs are scheduled by the same one UL grant.

In a second PUCCH transmitting method, each PUCCH may be transmitted from a carrier having different TTIs, and HARQ timing of the PDSCH or the PUSCH is different in an SFT carrier and an OST carrier. Therefore, a transfer time of a data channel through the SFT carrier and a transfer time of a data channel through the OST carrier are different. A type of a carrier that transmits a data channel using different transfer times may be differently set according to a time (i.e., a transfer time of a data packet) that is required for transfer of a data packet. In this case, a type of a carrier may be an SFT carrier or an OST carrier.

In another exemplary embodiment, the base station selects a type of a carrier to transmit a PDSCH according to a transfer time of a downlink data packet. In this case, a field that can distinguish a transfer time of the data packet may be included in the downlink data packet. Thereafter, the base station transmits DL assignment and a PDSCH through one carrier of carriers having a selected carrier type. In this case, a type of a carrier that transmits the DL assignment and the PDSCH is the same, but a carrier that transmits DL assignment and a carrier that transmits the PDSCH may be the same or different. Thereafter, the terminal transmits UL A/N to the base station through a carrier of the same type as that of a carrier in which the PDSCH is received.

Further, a type of a carrier that transmits the PUSCH may be different according to a transfer time of an uplink data packet. In another exemplary embodiment, the terminal or the base station may determine a carrier to transmit the PUSCH.

When the terminal selects a type of a carrier to transmit a PUSCH, the terminal selects a type of a carrier to transmit a PUSCH according to a transfer time of an uplink data packet. In this case, a field that distinguishes a transfer time of an uplink data packet may be included in the PUSCH. Thereafter, the terminal transmits an SR to the base station through one carrier of carriers having the selected carrier type. The base station transmits UL grant to the terminal through a carrier having the same type as that of a carrier in which an SR is received. The terminal receives UL grant and transmits a PUSCH to the base station through a carrier in which the UL grant indicates. The base station receives the PUSCH and transmits DL A/N to the terminal through a carrier to which the UL grant is transmitted.

When the base station selects a type of a carrier to transmit a PUSCH, the terminal transmits a BSR to the base station. In this case, the BSR may include a field that distinguishes a transfer time of an uplink data packet. The BSR may be transmitted to the base station through an SFT carrier or an OST carrier. The base station selects a type of a carrier to transmit the PUSCH based on the received BSR. Thereafter, the base station transmits UL grant to the terminal through a carrier of the selected carrier type. The terminal receives UL grant and transmits the PUSCH to the base station through a carrier in which the UL grant indicates. The base station receives the PUSCH and transmits DL A/N to the terminal through a carrier to which the UL grant is transmitted.

As described above, when a carrier having different TTIs is used, HARQ timing that is related to a physical channel is optimized and thus carrier aggregation can be efficiently performed.

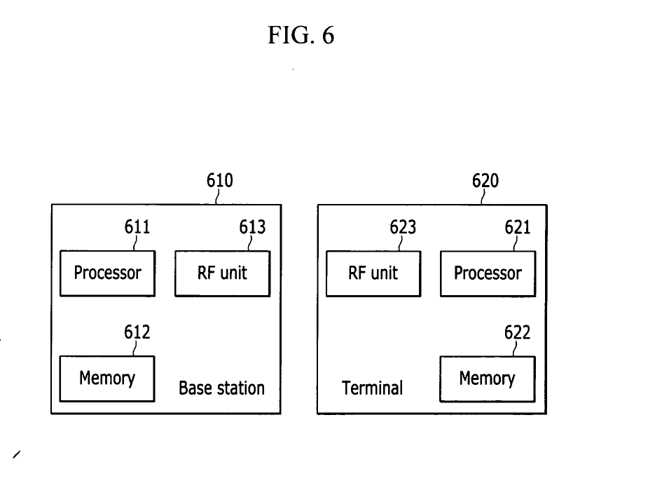

FIG. 6 is a block diagram illustrating a wireless communication system according to an exemplary embodiment of the present invention.

Referring to FIG. 6, a wireless communication system according to an exemplary embodiment of the present invention includes a base station 610 and a terminal 620.

The base station 610 includes a processor 611, a memory 612, and a radio frequency unit (RF unit) 613. The memory 612 is connected to the processor 611 to store various information for driving the processor 611 or at least one program that is executed by the processor 611. The RF unit 613 is connected to the processor 611 to transmit/receive a wireless signal. The processor 611 may implement a function, a process, or a method that is suggested in an exemplary embodiment of the present invention. In this case, in a wireless communication system according to an exemplary embodiment of the present invention, a wireless interface protocol layer may be implemented by the processor 611. Operation of the base station 610 according to an exemplary embodiment of the present invention may be implemented by the processor 611.

The terminal 620 includes a processor 621, a memory 622, and an RF unit 623. The memory 622 is connected to the processor 621 to store various information for driving the processor 621. The RF unit 623 is connected to the processor 621 to transmit/receive a wireless signal. The processor 621 may implement a function, a step, or a method that is suggested in an exemplary embodiment of the present invention. In this case, in a wireless communication system according to an exemplary embodiment of the present invention, a wireless interface protocol layer may be implemented by the processor 621. Operation of the terminal 620 according to an exemplary embodiment of the present invention may be implemented by the processor 621.

In an exemplary embodiment of the present invention, a memory may be located at the inside or the outside of a processor, and the memory may be connected to a processor through already known various means. The memory is a volatile or nonvolatile storage medium of various forms, and for example, the memory may include a read-only memory (ROM) or a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A terminal, comprising:
at least one processor;
a memory; and
a radio frequency unit,
wherein by executing at least one program that is stored at the memory, the at least one processor selects a type of a carrier to transmit a Physical Uplink Shared Channel (PUSCH) based on a transfer time that is required for transferring an uplink data packet and transmits a Scheduling Request (SR) to a base station through a first carrier of carriers having the selected carrier type.

2. The terminal of claim 1, wherein by executing the at least one program, the at least one processor receives Uplink grant (UL grant) from the base station through a second carrier having the same type as that of the first carrier, transmits a PUSCH to the base station through a third carrier in which the UL grant indicates, and receives Downlink ACK/NACK (DN A/N) from the base station through the second carrier.

3. The terminal of claim 2, wherein the second carrier is a Subframe TTI (SFT) carrier in which a Transmission Time Interval (TTI) is one subframe, and the third carrier is a One Slot TTI (OST) carrier in which the TTI is one slot.

4. The terminal of claim 2, wherein the at least one processor, when receiving Downlink ACK/NACK (DN A/N), transmits the PUSCH and receives the DL A/N after two slots when receiving the UL grant and transmitting the PUSCH to the base station after one slot, and transmits the PUSCH and receives the DL A/N after one slot when receiving the UL grant and transmitting the PUSCH to the base station after two slots.

5. The terminal of claim 2, wherein the first carrier and the second carrier are the same carrier.

6. The terminal of claim 2, wherein the at least one processor, when transmitting the PUSCH, determines a One Slot TTI (OST) to transmit the PUSCH based on a slot index that is included in the UL grant and transmits the PUSCH at the determined OST.

7. The terminal of claim 2, wherein the at least one processor, when transmitting the PUSCH, determines a One Slot TTI (OST) to transmit the PUSCH based on a scheduling indicator that is included in the UL grant and transmits the PUSCH at the determined OST.

8. A base station, comprising:
at least one processor;
a memory; and
a radio frequency unit,
wherein by executing at least one program that is stored at the memory, the at least one processor selects a type of a carrier to transmit a Physical Uplink Shared Channel (PUSCH) based on a Buffer Status Report (BSR) that is received from a terminal, transmits Uplink grant (UL grant) to the terminal through a first carrier having a type different from the selected carrier type, and receives the PUSCH through a second carrier that is instructed to the UL grant among the selected carrier types.

9. The base station of claim 8, wherein by executing the at least one program, the at least one processor transmits Downlink ACK/NACK (DL A/N) corresponding to the PUSCH to the terminal through the first carrier.

10. The base station of claim 9, wherein the first carrier is a Subframe TTI (SFT) carrier in which a Transmission Time Interval (TTI) is one subframe, and the second carrier is a One Slot TTI (OST) carrier in which the TTI is one slot.

11. The base station of claim 9, wherein the at least one processor, when transmitting the DL A/N, receives the PUSCH and transmits the DL A/N after two slots when transmitting the UL grant and receiving the PUSCH from the terminal after one slot, and receives the PUSCH and transmits the DL A/N after one slot when transmitting the UL grant and receiving the PUSCH from the terminal after two slots.

12. A base station, comprising:
at least one processor;
a memory; and
a radio frequency unit,
wherein by executing at least one program that is stored at the memory, the at least one processor selects a type of a carrier to transmit a Physical Downlink Shared Channel (PDSCH) based on a transfer time that is required for transferring a downlink data packet, transmits the PDSCH to a terminal through a first carrier of carriers having the selected carrier type, and receives Uplink ACK/NACK (UL A/N) corresponding to the PDSCH from the terminal through a second carrier having a carrier type different from the selected carrier type.

13. The base station of claim 12, wherein the first carrier is a One Slot TTI (OST) carrier in which a Transmission Time Interval (TTI) is one slot, and the second carrier is a Subframe TTI (SFT) carrier in which the TTI is a one subframe.

14. The base station of claim 13, wherein by executing the at least one program, the at least one processor transmits Downlink assignment (DL assignment) corresponding to the PDSCH to the terminal through the first carrier.

15. The base station of claim 14, wherein the at least one processor, when transmitting the PDSCH, transmits the PDSCH to the terminal after one OST when receiving UL A/N corresponding to a PDSCH that is transmitted at an odd numbered OST of two OSTs that are included in the SFT from the terminal and transmits the PDSCH to the terminal after two OSTs when receiving UL A/N corresponding to a PDSCH that is transmitted at an even numbered OST of the two OSTs from the terminal.

16. The base station of claim 13, wherein by executing the at least one program, the at least one processor transmits Downlink assignment (DL assignment) corresponding to the PDSCH to the terminal through the second carrier.

17. The base station of claim 16, wherein the at least one processor, when transmitting the PDSCH, transmits the PDSCH to the terminal after two OSTs when receiving UL A/N corresponding to a PDSCH that is transmitted at an even numbered OST of two OSTs that are included in the SFT from the terminal and transmits the PDSCH to the terminal after three OSTs when receiving UL A/N corresponding to a PDSCH that is transmitted at an odd numbered OST of the two OSTs from the terminal.

18. The base station of claim 16, wherein the DL assignment comprises a slot index representing whether a PDSCH in which the DL assignment schedules is scheduled at an even numbered OST or at an odd numbered OST.

19. The base station of claim 16, wherein the DL assignment comprises a scheduling indicator that represents a PDSCH that is scheduled at an even numbered OST and a PDSCH that is scheduled at an odd numbered OST.
